(19) United States
(12) Patent Application Publication
(10) Pub. No.: US 2018/0149338 A1
(43) Pub. Date: May 31, 2018

(54) SURFACE LIGHT SOURCE DEVICE

(71) Applicant: Enplas Corporation, Saitama (JP)

(72) Inventor: Kyouhei YAMADA, Saitama (JP)

(21) Appl. No.: 15/572,244

(22) PCT Filed: Apr. 21, 2016
(86) PCT No.: PCT/JP2016/062663

§ 371 Date: Nov. 7, 2017

(30) Foreign Application Priority Data
May 8, 2015 (JP) 2015-095644

(51) Int. Cl. F21V 13/04; F21V 3/02; F21S 2/00

(52) U.S. Cl. CPC F21V 13/04; F21Y 2105/16; F21S 2/005; F21V 3/02

(57) ABSTRACT

This surface light source is provided with a light diffusing plate and a plurality of light emitting devices. The plurality of light emitting devices each include a plurality of light emitting elements that are aligned in the second direction and have mutually different colors of emitted light, and a luminous flux control member that controls the distribution of the light emitted from the plurality of light emitting elements. The luminous flux control member includes an incident surface, total reflection surfaces, and two light guiding sections. The arrangement order of the plurality of light emitting elements in a given light emitting device differs from the arrangement order of the plurality of light emitting elements in another light emitting device adjacent thereto in the first direction or the second direction.

### TECHNICAL FIELD

The present invention relates to a surface light source device.

### BACKGROUND ART

Some transmission type image display apparatuses such as liquid crystal display apparatuses and sign boards use a direct surface light source device as a backlight. In recent years, direct surface light source devices having a plurality of light emitting elements as the light source have been used (see, for example, PTL 1).

The direct light source apparatus (surface light source device) disclosed in PTL 1 includes a light source substrate, a plurality of light sources (light emitting elements) that emit blue light disposed on the light source substrate, and a wavelength conversion sheet that is disposed with the light sources and an air layer therebetween, and contains a wavelength conversion material such as a phosphor and a quantum dot. In the surface light source device disclosed in PTL 1, when blue light emitted from the light source enters the wavelength conversion sheet, a part of the blue light is converted into red light and green light by the wavelength conversion material. The blue light, red light and green light are mixed into white light, and emitted out of the wavelength conversion sheet.

### CITATION LIST

### Patent Literature

### PTL 1

### Japanese Patent Application Laid-Open No. 2015-035336

### SUMMARY OF INVENTION

### Technical Problem

However, the surface light source device disclosed in PTL 1 uses an expensive wavelength conversion material such as a phosphor and a quantum dot, and consequently the manufacturing cost is high.

For the purpose of reducing the manufacturing cost, it is conceivable to use a combination of a plurality of light emitting elements whose emission light colors are different from one another instead of using the wavelength conversion materials for obtaining the three primary colors. However, in the case where a combination of a plurality of light emitting elements whose emission light colors are different from one another is used, the colors are required to be mixed without causing color unevenness. In particular, in the case where the thickness of the surface light source device is reduced or the case where light emitting elements (light sources) are disposed at a large pitch, it is difficult to sufficiently mix the colors, and color unevenness is easily caused.

In view of this, an object of the present invention is to provide a surface light source device that has, as the light source, a plurality of light emitting elements whose emission light colors are different from one another, and can suppress color unevenness without using wavelength conversion materials.

### Solution to Problem

A surface light source device according to the present invention includes: a plurality of light emitting devices; and a light diffusion plate configured to allow light emitted from the plurality of light emitting devices to pass therethrough while diffusing the light. The plurality of light emitting devices are disposed such that a plurality of light emitting device arrays each of which is composed of the plurality of light emitting devices arranged in a first direction are disposed in a second direction orthogonal to the first direction, each of the plurality of light emitting devices includes a plurality of light emitting elements whose emission light colors are different from one another, the plurality of light emitting elements being arranged in the second direction, and a light flux controlling member configured to control a distribution of light emitted from the plurality of light emitting elements, the light flux controlling member includes an incidence surface configured to allow incidence of light emitted from the plurality of light emitting elements, a total reflection surface configured to reflect, in the first direction and a third direction opposite to the first direction, a part of light incident on the incidence surface, and two light guiding parts disposed at opposite positions with respect to the incidence surface and the total reflection surface, the two light guiding parts being configured to guide, in the first direction or the third direction, a part of light incident on the incidence surface, and the plurality of light emitting elements are disposed such that an arrangement order of the plurality of light emitting elements in one light emitting device is different from an arrangement order of the plurality of light emitting elements in another light emitting device adjacent to the one light emitting device in the first direction or the second direction.

### Advantageous Effects of Invention

According to the present invention, it is possible to provide a surface light source device that has, as the light source, a plurality of light emitting elements whose emission light colors are different from one another, and can suppress color unevenness without using wavelength conversion materials.

### BRIEF DESCRIPTION OF DRAWINGS

FIGS. 1A and 1B illustrate a configuration of a surface light source device of Embodiment 1;

FIG. 2 is a sectional view of the surface light source device;

FIG. 3A to FIG. 3C illustrate a configuration of a light flux controlling member;

FIG. 4 illustrates light paths in a light emitting device;

FIG. 5 illustrates an arrangement of light emitting devices in the surface light source device according to Embodiment 1;

FIG. 6 illustrates an arrangement of light emitting devices in a surface light source device according to a comparative example;

FIG. 7A and FIG. 7B illustrate a measurement result of chromaticity X value on a light diffusion plate; and

FIG. 8 is a sectional view of a surface light source device according to Embodiment 2.

### DESCRIPTION OF EMBODIMENTS

Embodiments of the present invention are described below in detail with reference to the accompanying drawings.

### Embodiment 1

### (Configuration of Surface Light Source Device)

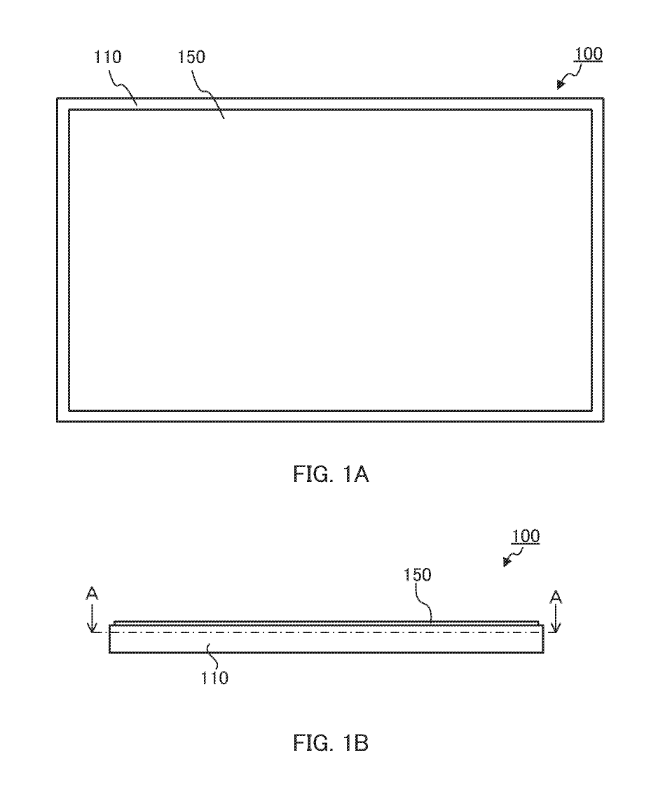

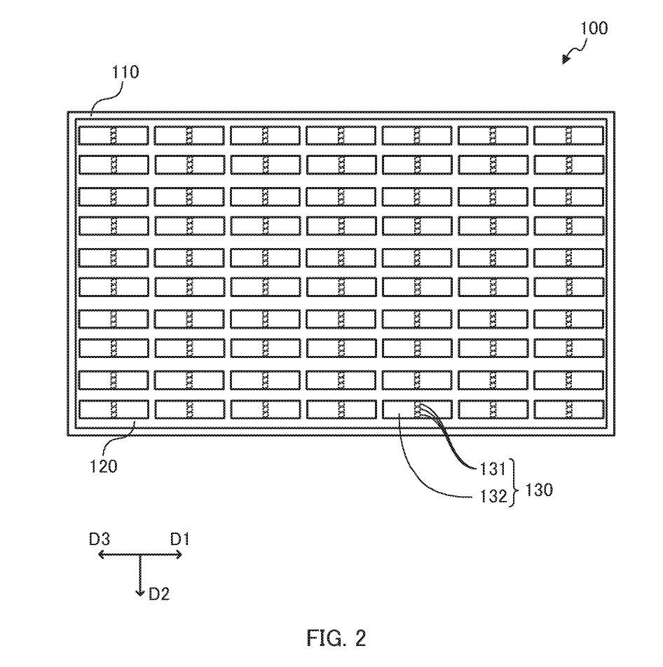

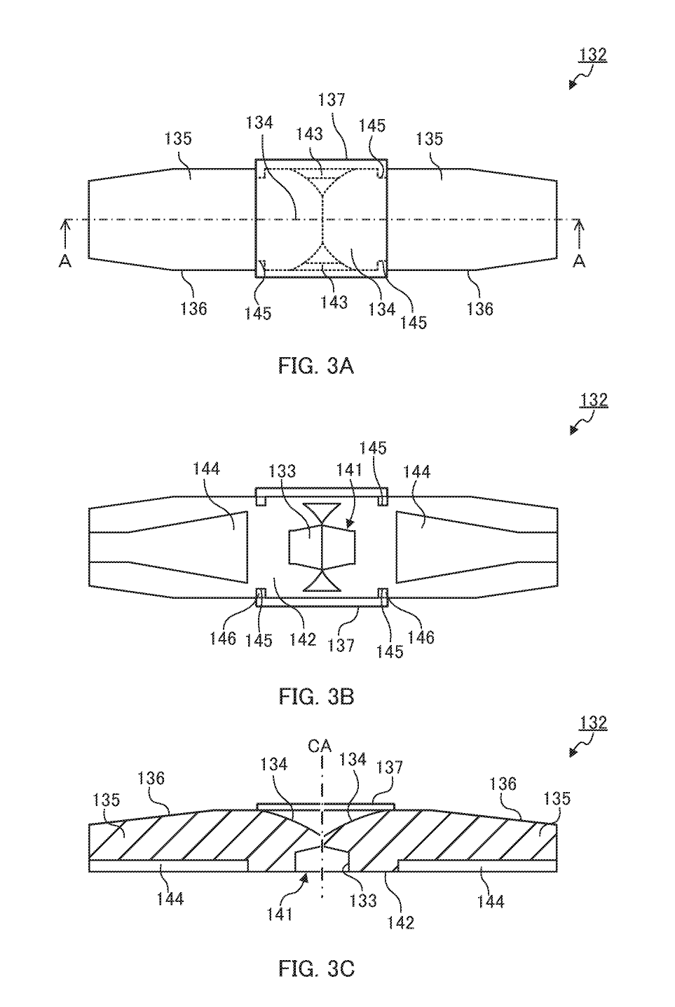

FIG. 1A to FIG. 2 illustrate a configuration of surface light source device 100 according to Embodiment 1. FIG. 1A is a plan view of surface light source device 100, and FIG. 1B is a side view of surface light source device 100. FIG. 2 is a sectional view taken along line A-A of FIG. 1B. FIG. 3A to FIG. 3C illustrate a configuration of light flux controlling member 132. FIG. 3A is a plan view of light flux controlling member 132, FIG. 3B is a bottom view of light flux controlling member 132, and FIG. 3C is a sectional view taken along line A-A of FIG. 3A.

As illustrated in FIG. 1A to FIG. 2, surface light source device 100 includes housing 110, substrate 120, a plurality of light emitting devices 130 and light diffusion plate 150.

Housing 110 is a cuboid box for housing substrate 120 and a plurality of light emitting devices 130 therein. At least a part of one surface of housing 110 is open. Housing 110 is composed of a top plate, a bottom plate opposite to the top plate, and four side plates that connect the top plate and the bottom plate. In the top plate, an opening of a rectangular shape that serves as a light emission region is formed. This opening is sealed with light diffusion plate 150. The size of the opening part corresponds to the size of the light emission region (light emitting surface) formed in light diffusion plate 150, and is, for example, 400 mm×700 mm (32 inch). The bottom plate and light diffusion plate 150 are disposed in parallel with each other. The height (distance) from the surface of the bottom plate to light diffusion plate 150 is, but not limited to, about 10 to 25 mm. Housing 110 is composed of a resin such as polymethylmethacrylate (PMMA) and polycarbonate (PC), a metal such as stainless steel and aluminum, or the like, for example.

Substrate 120 is a flat plate for disposing light emitting devices 130 in housing 110 at a predetermined interval. Substrate 120 is disposed on the bottom plate of housing 110. The number of light emitting devices 130 disposed on substrate 120 is not limited. The number of light emitting devices 130 disposed on substrate 120 is appropriately set based on the size of the light emission region (light emitting surface) defined by the opening part of housing 110. The surface of substrate 120 on which to dispose light emitting devices 130 is configured to reflect light arriving at the surface toward light diffusion plate 150.

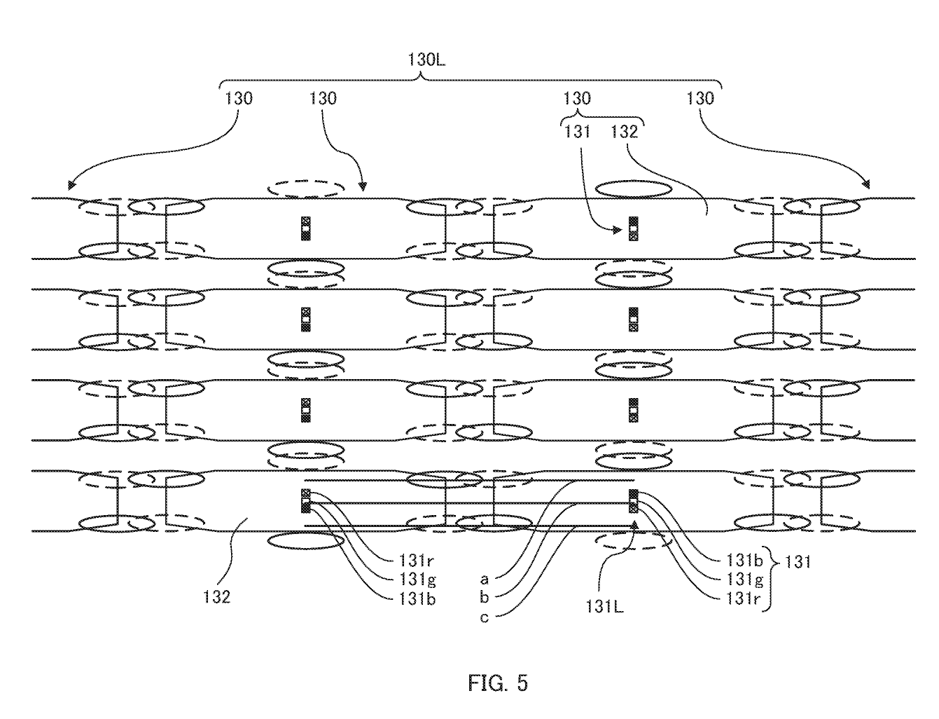

Each light emitting device 130 includes a plurality of light emitting elements 131, and light flux controlling member 132. Each light emitting device 130 is disposed such that the optical axis of light emitted from light emitting element 131 is set along the normal to the surface of substrate 120. A plurality of light emitting devices 130 are arranged in first direction D1 as light emitting device array 130L (see FIG. 5). Further, a plurality of light emitting device arrays 130L are disposed in the second direction orthogonal to the first direction.

Light emitting element 131 is the light source of surface light source device 100 (and light emitting device 130). Light emitting element 131 is disposed on substrate 120. Light emitting element 131 is a light-emitting diode (LED), for example. The colors of emission light of respective light emitting elements 131 included in one light emitting device 130 are different from each other. The colors of the emission light of light emitting elements 131 are not limited. In the present embodiment, one light emitting device 130 has light emitting element 131r configured to emit red light (R; red), light emitting element 131g configured to emit green light (G; green) and light emitting element 131b configured to emit blue light (B; blue). In addition, three light emitting elements 131r, 131g, and 131b in light emitting device 130 are disposed along second direction D2 perpendicular to first direction D1 so as to form light emitting element array 131L (see FIG. 5).

It is to be noted that one of the features of the present invention is the installation manner of each light emitting device 130 and the installation manner of light emitting element 131 in the light emitting device 130, and therefore the installation manners are described in detail later.

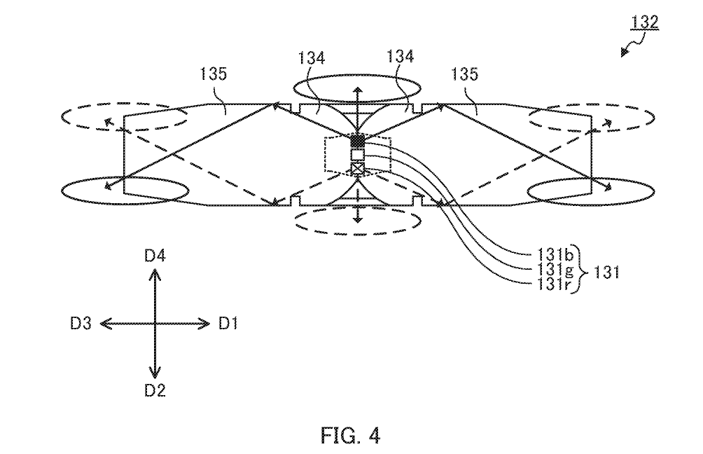

Light flux controlling member 132 controls the distribution of light emitted from light emitting element 131. As illustrated in FIG. 3A to FIG. 3C, light flux controlling member 132 includes incidence surface 133, total reflection surface 134, two light guiding parts 135, two emission surfaces 136 and cover 137. It is to be noted that light flux controlling member 132 may include a leg part (which is omitted in the drawing) for fixing substrate 120. Light flux controlling member 132 controls at least light emitted from light emitting element 131 such that the light advances in first direction D1 and third direction D3 opposite to first direction D1 to a certain degree, and then the light advances toward light diffusion plate 150 (see FIG. 4).

A part of light emitted from light emitting element 131 is incident on incidence surface 133. Incidence surface 133 is the internal surface of first recess 141 formed at a center portion of bottom surface (light emitting element 131 side surface) 142 of light flux controlling member 132. The shape of first recess 141 is not limited. The shape of first recess 141 may be an edgeless curved surface such as a hemispherical surface and a semi-ellipsoidal surface, or an edged surface having a top surface and a side surface. In the present embodiment, the shape of first recess 141 includes a top surface and a side surface.

Total reflection surface 134 is disposed on the side (light diffusion plate 150 side) opposite to light emitting element 131 with respect to incidence surface 133. In addition, total reflection surface 134 reflects, in third direction D3 and first direction D1 in which light emitting device 130 is arranged, a part of incident light from incidence surface 133. In a cross-section taken along a plane including a straight line along first direction D1 (third direction D3) and center line CA, total reflection surface 134 is formed such that, with central axis CA as a boundary, the height from bottom surface 142 (substrate 120) increases from central axis CA toward the both end portions. To be more specific, total reflection surface 134 is formed such that, in a cross-section taken along the above-mentioned plane, the inclination of the tangent gradually decreases from central axis CA toward the end portion.

Two light guiding parts 135 are formed at opposing positions with respect to incidence surface 133 and first total reflection surface 134. Light guiding parts 135 guide a part of light incident on incidence surface 133 and light reflected by total reflection surface 134 in the direction away from incidence surface 133 and total reflection surface 134 (first direction D1 or third direction D3), while outputting the light little by little. In addition, a pair of reinforcement members 143 is disposed so as to connect light guiding parts 135. The surface of light guiding part 135 on light diffusion plate 150 side functions as emission surface 136 that emits the guided light to the outside. Scattering members such as beads may be dispersed in light guiding part 135 from the view point of uniformization of the quantity of the light emitted from emission surface 136.

In the direction along first direction D1 and third direction D3, each emission surface 136 is disposed at a position remote from central axis CA relative to total reflection surface 134. Emission surface 136 emits, to the outside, a part of incident light from incidence surface 133 and light reflected by total reflection surface 134. In addition, a light diffusing treatment (for example, roughening process) may be performed on emission surface 136.

The shape of light guiding part 135 is not limited. In the present embodiment, light guiding part 135 is a member having a rod-like shape. The cross-sectional area of light guiding part 135 in the minor axis direction is not limited. In the present embodiment, the cross-sectional area of light guiding part 135 in the minor axis direction decreases as the distance from total reflection surface 134 increases. In addition, two light guiding parts 135 are continuously connected by reinforcement member 143. Further, guide engagement groove 145 is formed on each of the side surfaces of two light guiding parts 135.

In addition, second recesses 144 are respectively formed on bottom surface (the surfaces on light emitting element 131 side) 142 of light guiding parts 135. With second recesses 144, sink marks can be reduced at the time of injection molding, and the manufacturing cost can be reduced. Two second recesses 144 are each formed along the longitudinal axial direction of the center portion of light flux controlling member 132, but are not in communication with first recess 141. The size and the form of second recess 144 are not limited as long as the desired light distribution (the light distribution which does not reduce the effect of the present invention) can be obtained and the required strength of light flux controlling member 132 can be ensured. In addition, in the present embodiment, the depth and the shape in plan view of second recess 144 are also not limited, and can be appropriately set. It is to be noted that in the case where light flux controlling member 132 is formed by injection molding, it is preferable to form second recess 144 in a region where sink marks are possibly left.

Reinforcement member 143 improves the strength of light flux controlling member 132. The position and the shape of reinforcement member 143 are not limited as long as the function of total reflection surface 134 of light flux controlling member 132 is not significantly impaired, and the strength of light flux controlling member 132 can be improved. In the present embodiment, reinforcement member 143 is disposed on the side of bottom surface (the surface on light emitting element 131 side) 142 of light flux controlling member 132 so as to continuously connecting light guiding parts 135.

In the direction along first direction D1 and third direction D3, guide engagement grooves 145 are disposed at positions remote from central axis CA relative to reinforcement member 143. Guide engagement grooves 145 are grooves for setting the position of cover 137 described later with respect to light flux controlling member 132 by being engaged with engagement protrusions 146 of cover 137.

Cover 137 is disposed on the side opposite to light emitting element 131 with respect to incidence surface 133. Cover 137 allows transmitted light which has not been reflected by first total reflection surface 134 to pass therethrough while diffusing the light. The shape of cover 137 is not limited as long as the above-described function can be ensured. Examples of the shape of cover 137 include a half cylindrical shape, a temple bell-like shape (inverted U-shape) and the like. In the present embodiment, cover 137 has a bell-like shape. Engagement protrusions 146 that are engaged with guide engagement grooves 145 are disposed at end portions of cover 137 on light emitting element 131 side.

The material of light flux controlling member 132 is not limited as long as light of a desired wavelength can pass therethrough. Examples of the material of light flux controlling member 132 include: light transmissive resins such as polymethylmethacrylate (PMMA), polycarbonate (PC), and epoxy resin (EP); and glass.

Light diffusion plate 150 is disposed to close the opening part of housing 110. Light diffusion plate 150 is a plate-shaped member having a light diffusing property and allows the light emitted from light guiding part 135 to pass therethrough while diffusing the light. Normally, the size of light diffusion plate 150 is substantially the same as that of the member to be irradiated such as a liquid crystal panel. For example, light diffusion plate 150 is formed of a light transmissive resin such as polymethylmethacrylate (PMMA), polycarbonate (PC), polystyrene (PS), and styrene methyl methacrylate copolymerization resin (MS). In order to provide a light diffusing property, minute irregularities are formed on the surface of light diffusion plate 150, or diffusing members such as beads are dispersed in light diffusion plate 150.

Next, light paths of light emitted from light emitting elements 131 in light flux controlling member 132 in light emitting device 130 are described. FIG. 4 illustrates light paths in light emitting device 130.

Here, as illustrated in FIG. 4, light emitting device 130 in which the longitudinal axis of light flux controlling member 132 is disposed in the direction along first direction D1 is described. In addition, a plurality of light emitting elements 131 in the light emitting device 130 are disposed such that light emitting element 131b configured to emit blue light, light emitting element 131g configured to emit green light, and light emitting element 131r configured to emit red light are arranged in this order in second direction D2.

As indicated with the solid line in FIG. 4, a part of the light which is emitted from light emitting element 131b configured to emit blue light and is incident on incidence surface 133 is emitted as blue light from total reflection surface 134 of fourth direction D4 opposite to second direction D2 without being reflected by light total reflection surface 134. In addition, another part of the light which is emitted from light emitting element 131b configured to emit blue light and is incident on incidence surface 133 is advanced in light guiding part 135 and internally reflected by the surface of light guiding part 135, and, emitted as blue light in the second direction from an end surface of light guiding part 135. In addition, as indicated with the broken line in FIG. 4, a part of the light which is emitted from light emitting element 131r configured to emit red light and is incident on incidence surface 133 is emitted as red light from the total reflection surface of second direction D2 without being reflected by total reflection surface 134. In addition, another part of the light which is emitted from light emitting element 131r configured to emit red light and is incident on incidence surface 133 is advanced in light guiding part 135 and internally reflected by the surface of light guiding part 135, and, emitted as red light from an end surface of light guiding part 135 in fourth direction D4. In this manner, in light emitting device 130 of surface light source device 100 according to the present embodiment, the light emitted from a plurality of light emitting elements 131 is emitted out of light flux controlling member 132 without sufficient color mixture inside light flux controlling member 132. Consequently, light components of the colors are unbalanced on light diffusion plate 150 of surface light source device 100, and the region indicated with the solid line in FIG. 4 is colored with bluish white, while the region indicated with the broken line is colored with reddish white.

The present inventors studied the arrangement of light emitting devices 130 and the arrangement of light emitting elements 131 in each light emitting device 130 for the purpose of preventing color unevenness on light diffusion plate 150 in the case where light flux controlling member 132 that guides the light emitted from light emitting elements 131 in two opposite directions is used.

### (Arrangement of Light Emitting Devices)

Now, the arrangement of light emitting devices 130 (light emitting elements 131) in surface light source device 100 is described in detail. FIG. 5 is a schematic view for describing an arrangement of light emitting devices 130 (light emitting elements 131) in surface light source device 100. As illustrated in FIG. 5, in surface light source device 100 according to Embodiment 1, a plurality of light emitting devices 130 are arranged as light emitting device array 130L such that the longitudinal axis of light emitting device 130 (light flux controlling member 132) is set along first direction D1. In addition, a plurality of the light emitting device arrays 130L are disposed in second direction D2 orthogonal to first direction D1. As viewed along second direction D2, a plurality of light emitting elements 131 (light emitting element array 131L) included in one light emitting device 130 are disposed to overlap a plurality of light emitting elements 131 (light emitting element array 131L) included in another light emitting device 130 included in another light emitting device array 130L adjacent to the light emitting device array 130L including the one light emitting device 130 in second direction D2.

The arrangement order of light emitting elements 131 in one light emitting device 130 and the arrangement order of light emitting elements 131 in another light emitting device 130 adjacent to the one light emitting device 130 in first direction D1 or second direction D2 are different from each other. In the present embodiment, the arrangement orders of light emitting elements 131 are identical to each other between two light emitting devices 130 adjacent to each other in second direction D2. On the other hand, the arrangement orders of light emitting elements 131 are different from each other between two light emitting devices 130 adjacent to each other in first direction D1.

To be more specific, as illustrated in FIG. 5, in one light emitting device 130, light emitting element 131b configured to emit blue light, light emitting element 131g configured to emit green light, and light emitting element 131r configured to emit red light are disposed in this order in second direction D2. In addition, in another light emitting device 130 adjacent to the one light emitting device 130 in second direction D2, light emitting elements 131 are disposed in the same order.

On the other hand, in another light emitting device 130 adjacent to the one light emitting device 130 in first direction D1, light emitting element 131r configured to emit red light, light emitting element 131g configured to emit green light, and light emitting element 131b configured to emit blue light are disposed in this order.

In surface light source device 100 in which light emitting devices 130 are disposed in the above-mentioned manner, the color appearance pattern of the light emitted from one light emitting device 130 and the color appearance pattern of the light emitted from another light emitting device 130 adjacent to the one light emitting device 130 in first direction D1 or second direction D2 are different from each other. Thus, color mixture is caused between light emitting device 130 and light diffusion plate 150 as well as in light flux controlling member 132, and the color unevenness is suppressed.

### (Measurement of Chromaticity X Value)

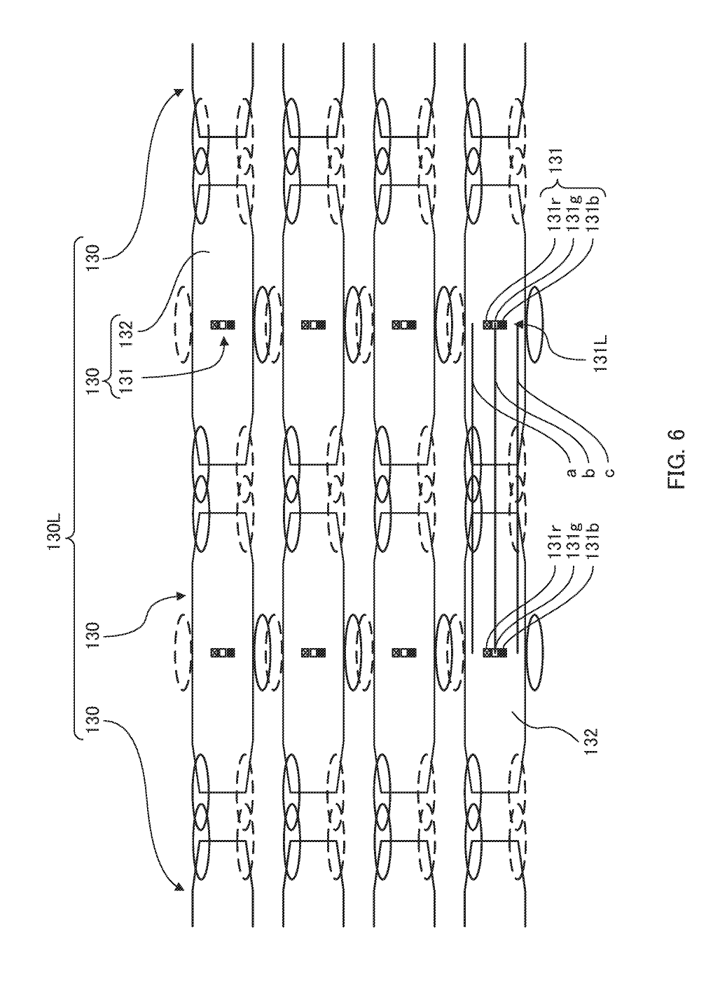

Next, a chromaticity X value (c) on light diffusion plate 150 was measured. Also, for comparison, a chromaticity X value on light diffusion plate 150 in light emitting device 130 according to a comparative example was measured. FIG. 6 illustrates an arrangement of light emitting devices 130 (light emitting elements 131) in a surface light source device according to the comparative example. As illustrated in FIG. 6, in surface light source device 100 according to the comparative example, the arrangement order of light emitting elements 131 is identical to one another among all light emitting devices 130.

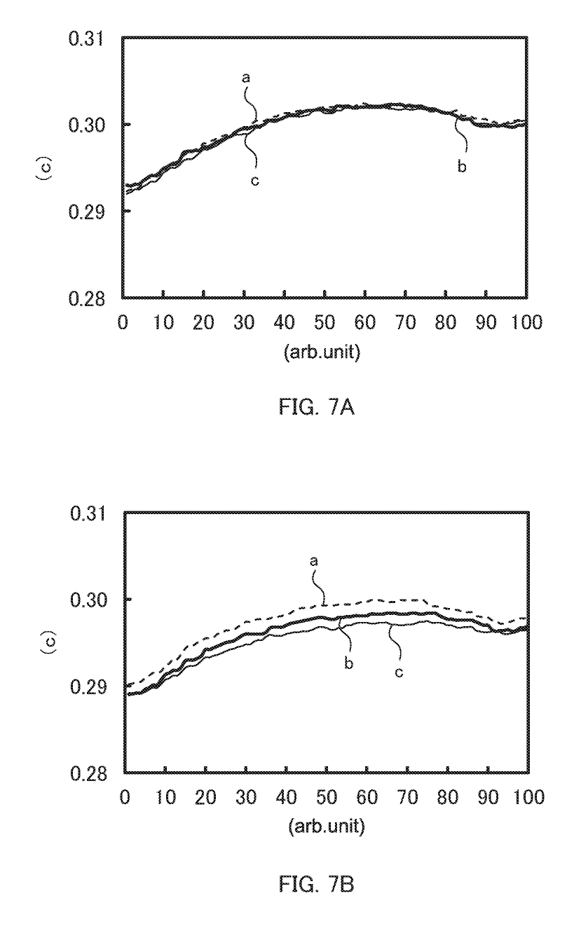

FIG. 7A is a graph showing a chromaticity X value on light diffusion plate 150 of surface light source device 100 according to Embodiment 1, and FIG. 7B is a graph showing a chromaticity X value on light diffusion plate 150 of the surface light source device according to the comparative example. In FIG. 7A and FIG. 7B, the abscissa indicates a measurement position on light diffusion plate 150, that is, the measurement position of “0” represents the position of light emitting element 131 in first direction D1, and the measurement position of “100” represents the position of adjacent light emitting element 131 in first direction D1. In addition, the measurement of the chromaticity X value was performed at the three positions (line segments a to c) illustrated in FIG. 5 and FIG. 6.

As shown in FIG. 7A, on light diffusion plate 150 of surface light source device 100 according to Embodiment 1, the chromaticity X values were substantially equal to each other (no color unevenness was caused) among all positions of the line segments a to c. It is considered that since the color appearance pattern of the light emitted from one light emitting device 130 is different from the color appearance pattern of the light emitted from adjacent light emitting device 130, the light emitted from light emitting devices 130 was sufficiently mixed.

On the other hand, as illustrated in FIG. 7B, on light diffusion plate 150 of the surface light source device according to the comparative example, the chromaticity X values were different from one another among parts of the line segments a to c (color unevenness was caused). It is considered that since the color appearance pattern of the light emitted from one light emitting device 130 and the color appearance pattern of the light emitted from adjacent light emitting device 130 were identical to each other, the color appearances of the same color were mixed together and emphasized.

### (Effect)

As described above, in surface light source device 100 according to the present embodiment, the arrangement order of light emitting elements 131 in one light emitting device 130 is different from the arrangement order of light emitting elements 131 in another light emitting device 130 adjacent thereto in first direction D1 or second direction D2, and thus the color appearance pattern of the light emitted from one light emitting device 130 is different from the color appearance pattern of the light emitted from the adjacent light emitting device 130. Accordingly, the light emitted from light emitting devices 130 are mixed together, and thus color unevenness can be suppressed.

### Embodiment 2

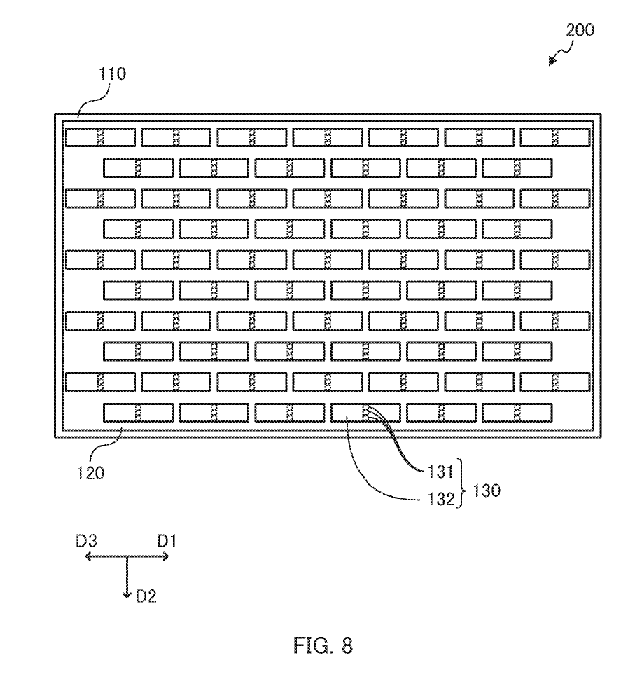

Next, with reference to FIG. 8, a surface light source device according to Embodiment 2 is described. Surface light source device 200 according to Embodiment 2 is different from surface light source device 100 according to Embodiment 1 only in the arrangement of light emitting devices 130 (light emitting elements 131). Accordingly, the same reference numerals are given to the components same as those of surface light source device 100 of Embodiment 1, and the descriptions thereof will be omitted.

As viewed along second direction D2, one light emitting element array 131L composed of a plurality of light emitting elements 131 included in light emitting device 130 is disposed between two light emitting element arrays 131L adjacent to each other in first direction D1 included in light emitting device array 130L adjacent to light emitting device array 130L that includes the one light emitting device 130 in second direction D2.

In addition, the arrangement order of light emitting elements 131 in one light emitting device 130 and the arrangement order of light emitting elements 131 in another light emitting device 130 adjacent to the one light emitting device 130 in first direction D1 or second direction D2 are different from each other. For example, the arrangement orders of light emitting elements 131 in two light emitting devices adjacent to each other in first direction D1 may be identical to each other or different from each other. In the case where the above-mentioned arrangement orders of light emitting elements 131 are identical to each other, the arrangement orders of light emitting elements 131 in two light emitting devices adjacent to each other in second direction D2 are different from each other.

Although not illustrated in the drawings, also in surface light source device 200 according to Embodiment 2, in surface light source device 100 in which light emitting devices 130 are disposed, the color appearance pattern of the light emitted from one light emitting device 130 and the color appearance pattern of the light emitted from another light emitting device 130 adjacent thereto in first direction D1 and second direction D2 are different from each other, and thus the light emitted from light emitting devices 130 are sufficiently mixed, and color unevenness is suppressed.

This application is entitled to and claims the benefit of Japanese Patent Application No. 2015-095644 filed on May 8, 2015, the disclosure each of which including the specification, drawings and abstract is incorporated herein by reference in its entirety.

### INDUSTRIAL APPLICABILITY

A surface light source device including the light flux controlling member according to the embodiments of the present invention is applicable to a backlight of a liquid crystal display, a sign board, a generally-used illumination apparatus and the like, for example.

### REFERENCE SIGNS LIST

100, 200 Surface light source device
110 Housing
120 Substrate
130 Light emitting device
130L Light emitting device array
131 Light emitting element
131L Light emitting element array
132 Light flux controlling member
133 Incidence surface
134 Total reflection surface
135 Light guiding part
136 Emission surface
137 Cover
141 First recess
142 Bottom surface
143 Reinforcement member
144 Second recess
145 Guide engagement groove
146 Engage protrusion
150 Light diffusion plate
CA Central axis
D1 First direction
D2 Second direction
D3 Third direction
D4 Fourth direction

1. A surface light source device comprising:
a plurality of light emitting devices; and
a light diffusion plate configured to allow light emitted from the plurality of light emitting devices to pass therethrough while diffusing the light, wherein:
the plurality of light emitting devices are disposed such that a plurality of light emitting device arrays each of which is composed of the plurality of light emitting devices arranged in a first direction are disposed in a second direction orthogonal to the first direction,
each of the plurality of light emitting devices includes
a plurality of light emitting elements whose emission light colors are different from one another, the plurality of light emitting elements being arranged in the second direction, and
a light flux controlling member configured to control a distribution of light emitted from the plurality of light emitting elements,
the light flux controlling member includes
an incidence surface configured to allow incidence of light emitted from the plurality of light emitting elements,
a total reflection surface configured to reflect, in the first direction and a third direction opposite to the first direction, a part of light incident on the incidence surface, and
two light guiding parts disposed at opposite positions with respect to the incidence surface and the total reflection surface, the two light guiding parts being configured to guide, in the first direction or the third direction, a part of light incident on the incidence surface, and
the plurality of light emitting elements are disposed such that an arrangement order of the plurality of light emitting elements in one light emitting device is different from an arrangement order of the plurality of light emitting elements in another light emitting device adjacent to the one light emitting device in the first direction or the second direction.

2. The surface light source device according to claim 1, wherein the light flux controlling member further includes a cover disposed on a side opposite to the light emitting element with respect to the incidence surface, the cover being configured to allow transmitted light which is not reflected by the total reflection surface to pass therethrough while diffusing the light.

3. The surface light source device according to claim 1, wherein the plurality of light emitting elements are disposed such that, as viewed along the second direction, one light emitting element array composed of the plurality of light emitting elements included in the light emitting device of one light emitting device array is disposed between other two light emitting element arrays adjacent to each other in the first direction which are included in another light emitting device array adjacent to the one light emitting device array in the second direction.

4. The surface light source device according to claim 1, wherein the plurality of light emitting elements are disposed such that, as viewed along the second direction, one light emitting element array composed of the plurality of light emitting elements included in the light emitting device of one light emitting device array overlaps another light emitting element array which is included in another light emitting device array adjacent to the one light emitting device array in the second direction.

5. The surface light source device according to claim 2, wherein the plurality of light emitting elements are disposed such that, as viewed along the second direction, one light emitting element array composed of the plurality of light emitting elements included in the light emitting device of one light emitting device array is disposed between other two light emitting element arrays adjacent to each other in the first direction which are included in another light emitting device array adjacent to the one light emitting device array in the second direction.

6. The surface light source device according to claim 2, wherein the plurality of light emitting elements are disposed such that, as viewed along the second direction, one light emitting element array composed of the plurality of light emitting elements included in the light emitting device of one light emitting device array overlaps another light emitting element array which is included in another light emitting device array adjacent to the one light emitting device array in the second direction.
